(19) United States
(12) Patent Application Publication
(10) Pub. No.: US 2013/0262254 A1
(43) Pub. Date: Oct. 3, 2013

(54) System and method for organizing trade via the internet

(71) Applicant: Michael Barabash, Katonah, NY (US)

(72) Inventor: Michael Barabash, Katonah, NY (US)

(21) Appl. No.: 13/506,162

(22) Filed: Apr. 2, 2012

(51) Int. Cl. G06Q 30/06

(52) U.S. Cl. 705/26.2

(57) ABSTRACT

A method of organizing a trade includes in an electronic data processing system introducing by a plurality of users information about the users and about items which they are willing to buy and to sell, searching by the users information about items which they are willing to sell and to buy, generating connection between them, and based on the connections finding a plurality of groups of users, such that in each group of users there are a buy only buyer, a sell-only seller, and a plurality of buy/sell traders.

### BACKGROUND OF THE INVENTION

The invention relates broadly to trade and commerce and, more particularly relates to a system that enables users seeking to exchange one item for another to enter and list information via the Internet about the item they wish to sell, and exchange, search other similarly listed items offered, select an item they want in exchange for the item they listed, which is then linked, and create a trading scenario for a transaction in which a group of linked items are automatically bought, sold, and exchanged.

Trade is the business of buying and selling commodities (commerce), for example, an act or an instance of buying or selling (i.e., a transaction). In another sense, trade is the transfer of ownership of goods from one person or entity to another. A network that allows trade is called a market or exchange, where the common medium of exchange is money.

Traditionally, one participant is a seller (i.e., he or she has the item for sale) and the other is the buyer (i.e., he or she wants to purchase the item for sale). The types of goods traded today are innumerable. Any product or device imaginable is bought or sold in “brick and mortar” shops and stores, in on-line exchanges (websites directed to buying and/or selling) and traditional exchanges.

More recently, the global network commonly referred to as the “Internet” has been used to advertise particular items to potential buyers. Such uses are primarily limited to situations in which a seller advertises a particular item by posting a listing on an “electronic bulletin board” which may be read by potential buyers. The buyers can then contact the sellers or the seller's agent by telephone or by electronic mail.

Various methods and techniques are known to match buyers with sellers of various types of items. Instead of searching item by item to find a desired item, a buyer searches the database using certain criteria such as price, nature, etc. This permits the buyer to avoid spending time looking at items which are of only tangential interest or no interest at all. In recent times, advances in data storage and retrieval methods and communications methods have permitted more sophisticated approaches to performing at least the initial step of matching buyers and sellers.

Once an item is found that interests a buyer, the buyer contacts the seller and the buyer and seller then attempt to agree on an amount to complete the transaction. Upon determining a fair price for the transaction, the buyer must meet the agreed to sale price.

Oftentimes, a buyer is a current owner of another item and his/her ability to meet the agreed upon price for the new item is contingent upon the sale of the other (old) item. That is, sale of the old item is a condition precedent to the buyer completing the transaction for purchase of the new item. For that matter, there also is a time constraint in purchasing an item. That is, once a buyer decides to purchase an item from a seller and if the buyer cannot do so because he/she is unable to sell his/her item, the seller may back out of the contracted for purchase.

Accordingly, there has been a need for a system which increases the ability of a potential buyer to both purchase a new item and sell another item and a potential seller to both sell a new item and buy another item in a related transaction or scenario.

### SUMMARY OF THE INVENTION

It is an object of the invention to overcome the aforementioned limitations of the prior art.

It is another object of the invention to provide system and method of operating as a that inherently increases the number of potential buyers and sellers for items listed on it.

It is another object of the invention to provide system and method of operating as a market where participants who wish to exchange one item for another (for example, used cars, commodities, or any type of heterogeneous of homogenous classes of goods or services for that matter); list the item the user wishes to exchange and links same with another listed item by selection of same. The selected item which defines a linking may be a user-listed item for exchange or a sale-only item listed by a Seller (only).

Any transaction must include in a group at least one sale-only item listed by a seller, at least on buy-only item listed by a buyer, and at least one or a plurality of items listed by traders or buyers/sellers.

In one embodiment, the invention comprises a method of organizing a trade comprising introducing into an electronic data processing system via Internet by a plurality of traders (buyers/sellers) information about the users and items which they are willing to sell and to buy, by at least one buyer information about one item he/she is willing to buy, and by at least one seller information about an item he/she is willing to sell and searching in the electronic data processing system by the users of the plurality of users information about items which they are willing to buy, and to sell.

In the event that the users find item in said electronic data processing system which they are willing to buy and to sell, generating by the electronic data processing system a connection between the items, and based on connections so formed, findings by the electronic data processing system in the plurality of users a plurality of groups of users, such that in each of the groups of users all items of all users of each of the groups can be sold and bought exclusively by the traders, bought by a buyer, and sold by a seller within each of the groups. The same buyer and seller and traders defines the group transaction/scenario, where most preferably where time is of the essence, there are only one buyer, only one seller and multiple traders. A transaction is completed when, after all items in a group have been selected by the buyer, the seller and the traders (buyers/sellers).

Generally, registration of all users who wish to trade as buyers, sellers and traders is required. In addition, it is preferred that they login to list and items for sale and buy, in association with their roles as a trader or a seller or a buyer.

### BRIEF DESCRIPTION OF THE DRAWINGS

FIG. 1 is a block diagram of a system which can be used to implement a method of the invention;

FIG. 2 is a block-diagram representing an electronic device programmed for implementing the method of the invention;

FIG. 3 is a computer/server readable medium upon which computer/server readable instructions may be stored, where upon execution of the instructions implements a method of organizing trade;

FIG. 4 is a view showing a system level depiction of a group of traders, a buyer and a seller;

FIG. 5 is a view showing a system level depiction of a group traders, multiple buyers and multiple sellers.

### DESCRIPTION OF THE PREFERRED EMBODIMENTS

The invention utilizes an electronic system, for example, a computer processing system, preferably a computer server and/or a database server, which receives data related to items to buy and to sell, and organizes the data to facilitate trade. To be part of a trade, a user (buyer) who wishes to buy an item must list an item to buy, a user (seller) who wishes to sell an item must list an item to sell, and users or traders (buyers/sellers) must list items to buy and to sell. The system calculates and creates scenarios or “matches” of a number of items, with a number of users or entities who want to buy and sell the respective listed items.

The inventive system and method obviates a need to spend hours and hours to find people who want to buy an “old item,” which transaction must be concluded prior to or at the time that the seller of the “old item” is able to complete a purchase of a new item. That is, instead of spending time and effort searching for buyers of an “old item” that must be sold to bankroll a purchase of a new item, the “old item” owner can concentrate his/her time and effort on search for new items to buy, as the trade or transaction in a selected “new item” is not completed, or consummated until a buyer for the “old item” is ready, willing and able to buy.

The items for trade may be any item of value, for example, cars, trucks, boats, planes, commodities, stocks, artwork, even services without limitation.

Preferably, all items to be organized for sale are identified by identification (ID), which is a number or alphanumeric code assigned to the item at the time it is listed with the system, and its associated data are stored. For example, all items might be listed as a member of an array, such as A, where the number associated with each is an integer index i. Hence each item and an array member, or ID, would be identified as Ai (e.g., A₂₃₆₅).

A connection links an item that a user selects to buy with the item the user lists for sale. Table 1 lists a plurality of connection between items for sale (Sell IDs) and items selected to buy (Buy IDs) by the buyer, seller, and user, traders (buyers/sellers). For example, a trader who has listed item identified by number 156 for sale in a role of seller, has also selected two items to buy, items 1845 and 654, in a role as buyer. For that matter, a trader may have multiple items listed for sale. Similarly, a trader who has listed item 1845 for sale in a role as seller also has selected item 733 to buy in a role of buyer. Two traders in their roles as seller of items 434 and 733 have selected item 156 to buy in their respective roles as buyers. A trader who has listed item 856 for sale in a role as seller also has selected item 34 to buy in a role of buyer in and a trader who has listed item 29876 for sale in a role as seller also has selected item 4296 to buy in a role of buyer, etc.

TABLE 1

| Sell ID | Buy ID |
|---|---|
| 156 | 1845 |
| 156 | 654 |
| 1845 | 735 |
| 434 | 156 |
| 733 | 156 |
| 856 | 34 |
| 29876 | 4216 |
| 735 | 2525 |

The system implements a connection engine (CE) that calculates the scenario, or trades using the information entered by users and memory-stored, e.g., in a database. The connection engine process selected items with the connected item for sale, for example:

Buyer wants to buy ItemID=156

### BuyerID=B234

### B234=>156=>1845=>735=>2525

In the case of the example in Table 1. Since item the trader (buyer/seller) listing item 156 wants to purchase item 1845, the seller of item 1845 wants purchase item 735, as soon as the seller of item 735 selects to buy item 2525, there is a trading scenario because each of the four items has a buyer and a seller.
We have one buyer, one seller and three buy/sell traders.
As the database may store and list many classes of items, e.g., cars, boats, books, antic, arts and even services that can be priced. As the reader can imagine, as there can be innumerable items in a database, some transactions will have only several items, but some transactions may be complex having many items. For that matter, scenarios can be limited to number of items listed in a database.

Once a trade is established, the system sends a message to all users who are members of a scenario, or trade transaction. The user may then execute the trade or system can automatically execute this financial transaction where all users have enough credit on a system. As such, the system does not need “matching criteria” or a “base” item for which scenario is created. All items are equal in the system and the number of scenarios depends on number of items and connections stored in a database.

It is important that when a trader (buyer/seller) found the transaction, upon completion of the transaction he can get a gap price or difference between the price of a sold item and a bought item (positive or negative).

There may be many ways to select items for a scenario. For example, the system may operate on SQL statements to create the scenarios. An important requirement to enable the system to calculate scenarios is the structure of listed items and the connections comprising information about what item is buying what item Ai buying item Aj. If this field exists, the scenario may be created.

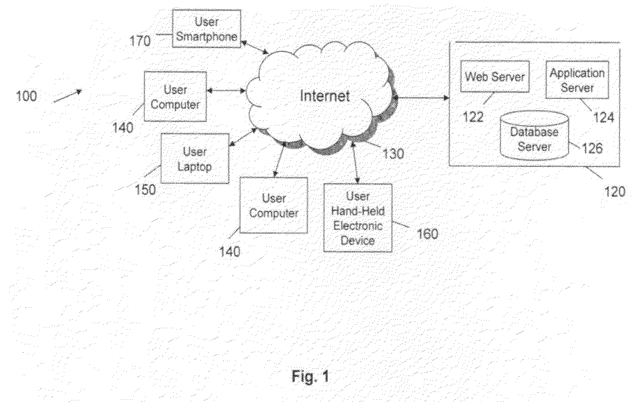

FIG. 1 illustrates one form of a system, or network, for organizing trade 100, according to the invention.

The system or network may be managed as a business by an organization. As shown in FIG. 1, the system or network for organizing trade includes a processing system 120 that is interconnected to a number of users through the Internet 130. Processing system 120 comprises web server 122, application server 124 and database server 126, which provides for inventive operation. User may connect to the processing system 120 via user computers 140, user laptops 150, user hand-held devices 160, user smart phones 170, telephones, PDAs, notebook computers, without limitation, to register to trade, including providing personal and/or financial information to log in, to enter information about the item they wish to list for sale, to search for items to buy, to select items to buy, to send and receive communications to the system, and other users, to execute financial transactions such as payment for a purchase, etc.

The users (by their respective electronic devices) may connect directly to the processing system 120, for example, in a network (not shown), wirelessly, via a telephone exchange or satellite communication system, or indirectly through the Internet 130. The processing system 120 may include an internal memory storage (not expressly shown), external memory storage 180 to which it is directly connected, or connected via a network, or to which it is connected via the Internet. The processing system 120 may be a database programmed to implement the method of the invention.

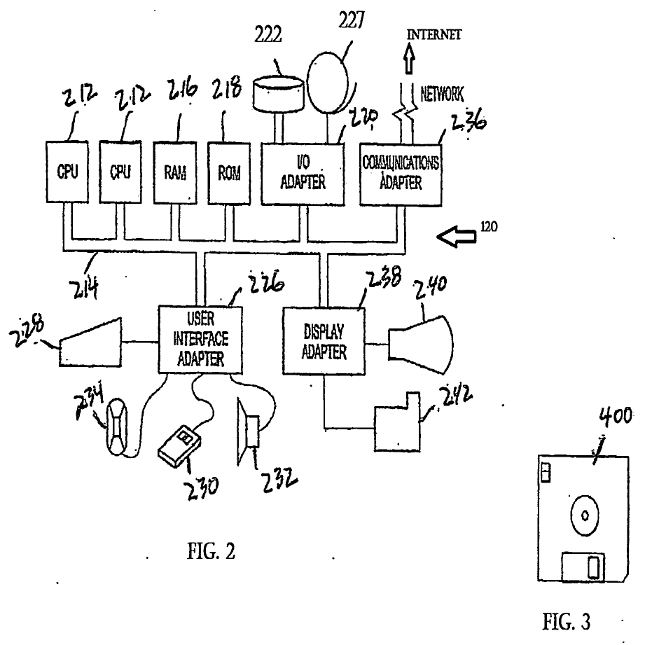

FIG. 2 illustrates a typical hardware configuration of electronic device, such as a database server 126 of processing system 120 for implementing the method of organizing trade in accordance with the invention. Database server 126 preferably has at least one processor or central processing unit (CPU) 212. CPUs 212 are interconnected via a system bus 214 to a random access memory (RAM) 216, read-only memory (ROM) 218, input/out (I/O) adapter 220 (for connecting peripheral devices such as disk units 222 and tape drives 224 to the bus 214), use interface adapter 226 (for connecting a keyboard 228, mouse 230, speaker 232, microphone 234, and/or other user interface device to the bus 214), a communications adapter 236 for connecting an information handling system to a data processing network (either wireline or wireless), the Internet, an Intranet, a personal area network (PAN), etc., and a display adapter 238 for connecting the bus 214 to a display device 240 and/or printer 242 (e.g., a digital printer or the like).

In addition to the hardware/software environment described above, a different aspect of the invention includes a computer-implemented method for performing the above method. As an example, this method may be implemented in the particular environment discussed above. Such a method may be implemented, for example, by operating a computer, as embodied by a digital processing apparatus, to execute a sequence of machine-readable instructions. These instructions may reside in various types of signal-bearing storage media.

The method of organizing trade, operable in an electronic device with memory storage (such as a database processor 126 of processing system 120), which is programmed to implement the method in the form of certain steps is disclosed. Includes a step of users connecting the processing system and registering to trade. Users must connected to and log on the processing system in order to list an item for sale, list an item to buy, search for items to sell, search for items to buy, select, etc., as known by those with skill in the art. Several steps or actions must take place prior to the step of listing, in order to render the system operational. For example, the system must be configured to operate for a particular service, and therefore the processing system must be incorporated and accessible in the organization's network, or at linked to the organization's service in such as way to enable buyer, sellers, and traders (buyers/sellers) electronic access to the processing system 120, and allow the processing system 120 the ability to communicated directly to the users. Hence, users (through their browsers) must connect to a user's interface made available by the processing system, in a communication session.

Searching the memory storage (in a database or other means for storing data), is carried out by buyers, sellers and traders (connected to the processing system). Selecting by the buyers items to buy, listing by the sellers items to sell, selecting the traders of items to buy and listing items to sell is performed. Based on the selection automatically connections are generated between items selected to buy by the buyers or traders in their roles as buyers, items listed for sale by the sellers or traders in their roles as sellers. Linking of generated connections is carried out to listing users. That is, every item selected to buy by a user in their role as a buyer is linked in the connection to the item listed for sale by the buyer, in their role as a seller, which is a condition precedent to enable a user to participate in a trade or transaction.

A trade scenario is established represented by a grouping of connections in which every seller, linked in a connection in said grouping by association with said connection's selected item to buy, has selected an item to buy listed for sale by said connection's buyer, wherein a trader (buyer/seller) exist for every item in every connection in said grouping and there is at least one buyer-only and at least one seller-only. Hence, every connection's item for sale is listed in another connection, in the grouping of connections comprising a trade scenario or transaction, as an item selected to buy, and no item linked in a transaction stands outside the scenario, or list of linked connections. Put another way, when every associated item has a buyer, and every buyer's associated item has a seller and also at least one item to buy only at least one item to sell only all linked by being in the grouping of connections the trade scenario is established. Once the scenario is established, or closed, the respective users may be contacted to implement the actual purchases, the actual purchases may be executed automatically, including that the system automatically interacts with the users' banks, etc., based on the way the system is configured to meet an organization's particular requirement.

Thus, these aspects of the present invention is directed to a programmed product, comprising signal-bearing storage media tangibly embodying a program of machine-readable instructions executable by a digital data processor incorporating the CPU 212 and hardware above, to perform the method of organizing trade of the invention.

This signal-bearing storage media may include, for example, a RAM contained within the CPU 212, as represented by the fast-access storage for example. Alternatively, the instructions may be contained in another signal-bearing storage media, such as a magnetic data storage diskette 400 (FIG. 3), directly or indirectly accessible by the CPU 212.

Whether contained in the diskette 400, or some other computer readable medium, the processing system 120, or database server 126 comprising CPU 212, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape). Other suitable signal-bearing media include memory devices in transmission media and instructions stored in formats such as digital and analog and memory devices in communication links and wireless. In an illustrative embodiment of the inventive, the machine-readable instructions may comprise software object code. It should also be obvious to one of ordinary skill in the art that the technique of the present invention could be implemented on a network in a variety of configurations.

Hence, the invention includes a computer program product and a set of processor readable instructions that when executed by a processor execute a method for organizing trade.

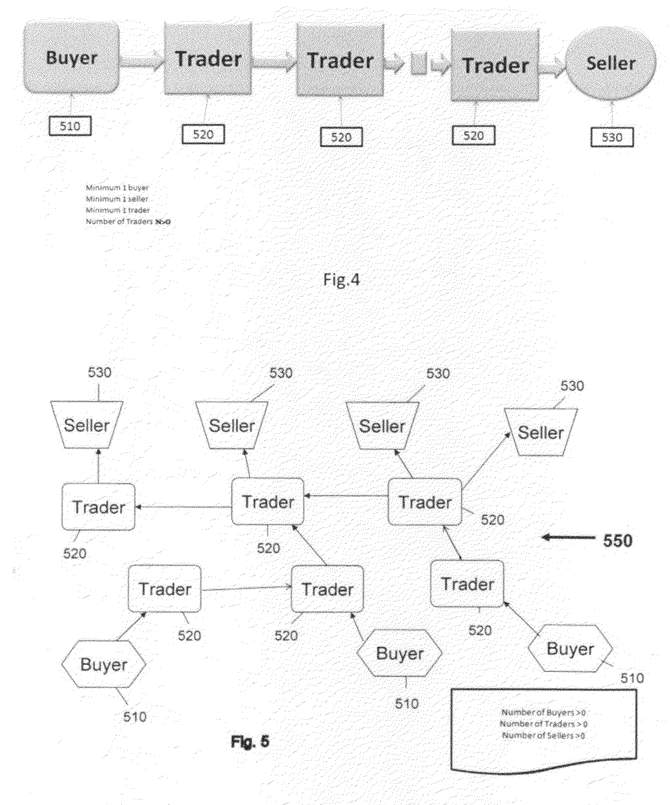

The invention includes a method of organizing trade shown in FIG. 4 and depicting such a scenario (500) where there are N Traders (520), only one Buyer (510) and only one Seller (530).

During intended operation, the item listed by the Trader (520), which the trader wishes to buy, is linked with another listed item when another trader (520) is willing to sell. Of course the other listed item must be listed by another trader (520), etc. The buyer (510) does not sell any item (in a transaction) but only purchases a Trader-listed item. The seller (530) does not buy any item (in a transaction) but only sells an item.

FIG. 5 depicts an alternative scenario (550) for such a trade. In the scenario 500, there may be more than 1 buyer (510) and more than 1 seller (530).

The electronic data system 120 may be configured to be part of a system of network for organizing trade (FIGS. 4 and 5). The electronic data processing system includes means for listing in an electronic data processing system by traders (520) items which the traders (520) seek to sell, means for listing in the electronic data processing system by sellers (530) item for sale-only, means for listing in the system Buyer ID by buyers (510), means for searching the electronic data processing system the items to buy and to sell, means for linking the selected items, thereby defining a transaction.

Although examples of the invention have been shown and described, it would be appreciated by those skilled in the art that changes may be made in these embodiments without departing from the principles and spirit of the invention, the scope of which is defined in the following claims and their equivalents.

1. A method of organizing a trade, comprising the steps of:
Introducing via the Internet into an electronic data processing system by a plurality of users information about the users and items which they are willing to sell;
searching via the Internet in said electronic data processing system by said same users of said plurality of users, information about items which they are willing to buy;
in the event that one of said plurality of users finds an item in said electronic data processing system which he is willing to buy, establishing a connection between an item to sell, information about which said one user introduced into said electronic data processing system, and the item to buy, information about which said one user found in said electronic data processing system; and
based on connections so formed, finding by said electronic data processing system in said plurality of users a plurality of groups of users, such that in each of said groups of users all items of all users of each of said groups can be sold and bought exclusively by all said users within each of said groups;
wherein at least one user in each of said groups is a buy-only buyer, at least one user in each of said groups is sell-only seller, and remaining users in each of said groups are buy/sell traders.

2. The method as set forth in claim 1, further comprising a step of communicating electronically via the Internet to all users in said groups of users that all items can be sold and bought.

3. The method as set forth in claim 1, further comprising a step of completing a transaction when, after all items in a group have been selected by said buy/sell traders, said sell-only seller, and said buy-only buyer.

4. A computer program product including a set of processor readable instructions that when executed by the processor execute a method of organizing a trade, as set forth in claim 1.

5. A system for organizing a trade, comprising:
an electronic data processing system;
means for introducing into said electronic data processing system via the Internet, by a plurality of users, information about the users and items which they are willing to sell;
means for searching in said electronic data processing system via the Internet by said same users of said plurality of users information about items which they are willing to buy;
means for generating a connection between an item to sell, information about which was introduced by one user of said plurality of users, and an item to buy, information about which was found by said one user, in the event that said one user finds said item he is willing to buy, and
means for finding a plurality of groups of users based on connections, such that in each of said groups all items of all users of each of said groups can be sold and bought exclusively by all said users within each of said groups, wherein at least the user in each of said groups is a buy-only buyer, at least one user in each of said groups is sell-only seller and the remaining users in each of said groups are buy/sell traders.

6. The system set forth in claim 5, further comprising means for organizing a transaction in which after all items in a group have been selected by said buy/sell traders, at least one sell-only seller, and said at least one buy-only buyer.

7. A method of organizing trade, operable in a processor with memory storage and programmed to implement the method, comprising steps of:
registering, in the memory storage, buyers, sellers, and buy/sell traders;
listing, in the memory storage, items for sale by said sellers and buy/sell traders;
searching the memory storage, by said buyers and by said buy/sell traders to buy items listed for sale;
selecting by said buyers and by buy/sell traders items listed for sale;
based on the selecting by said buyers, automatically generating connections between said buyers and said selected items to buy;
based on the selecting by said buy/sell traders automatically generating connections between said items to sell by said buy/sell traders and said items to buy by said buy/sell traders.
establishing a trade scenario represented by a grouping of said connections,
so that each group has a buy-only buyer, a sell-only seller and buy/sell traders.

8. The method as set forth in claim 7, further including a step of registering users who are buy-only buyers, sell-only seller, and buy-sell users.

9. The method as set forth in claim 7, further comprising providing in the processor a computer server configured to implement a communication function that enables user computers to connect via the Internet to and interact with the server during the steps of listing, searching and selecting.

10. The method as defined in claim 7, further comprising configuring the processor in accordance with particular trade schemes.

11. The method as set forth in claim 7, wherein said processor with memory storage comprises or is connected to a database.

12. The method as set forth in claim 7, further automatically communicating with all users involved in a trade scenario, upon selecting to a final or last item for sale or trade that establishes the scenario or trade.

13. A computer program product including a set of processor readable instructions that when executed by a processor execute a method of organizing trade, as set forth in claim 7.
